(19) United States
(12) Patent Application Publication
(10) Pub. No.: US 2023/0093642 A1
(43) Pub. Date: Mar. 23, 2023

(54) METHODS OF PASSIVATING FUEL MATERIALS FOR USE IN SOLID PROPELLANTS, AND RELATED SOLID FUELS, RAMJET ENGINES, AND METHODS

(71) Applicant: Northrop Grumman Systems Corporation, Falls Church, VA (US)

(72) Inventors: Devon S. Swanson, Fort Ashby, WV (US); Matthew S. Scott, Fort Ashby, WV (US)

(21) Appl. No.: 17/408,798

(22) Filed: Aug. 23, 2021

(51) Int. Cl. C10L 7/02; F42B 15/00

(52) U.S. Cl. CPC C10L 7/02; F42B 15/00; C10L 2270/00; C10L 2250/04

(57) ABSTRACT

A method of forming a solid fuel. The method comprises passivating a fuel material comprising a metalloid. Passivating the fuel material comprises combining the fuel material, a solvent, and an isocyanate passivation agent to form a solution, and passivating exposed surfaces of the fuel material with the isocyanate passivation agent to form a passivated fuel material. The method further comprises combining the passivated fuel material with at least one binder to form a mixture, and combining a curing agent with the mixture to form a solid fuel. Related solid fuels, solid fuel ramjet engines, and methods of passivating boron and forming a solid fuel ramjet engine are also disclosed.

### TECHNICAL FIELD

Embodiments of the disclosure relate generally to a method of passivating a fuel material to be used in a solid fuel mixture for use in a solid propellant propulsion engine. More particularly, embodiments of the disclosure relate to a method of passivating amorphous boron to form passivated amorphous boron, to related methods of forming a solid fuel mixture comprising particles of passivated amorphous boron, to related methods of forming solid fuel (e.g. propellant) ramjet engines, and to related solid fuel and ramjet engines.

### BACKGROUND

Propulsion engines, such as solid rocket motors and jet engines, use solid fuel materials (e.g., solid propellants) that may comprise fuel materials (that may comprise energetic materials or propellant materials) and non-energetic materials. Improving the performance of the propulsion engines typically requires increasing the performance of the fuel material, increasing the mass of fuel material, decreasing the mass of the non-energetic material, or some combination of these modifications. Because propulsion engines are volume-limited systems, reducing the volume of non-energetic materials in the propulsion engine allows for an increase in the volume and mass of the fuel materials.

Airbreathing propulsion engines increase the combustion efficiency of the solid fuel mixture by providing the oxidizer for combustion from air rather than as a component of the solid fuel mixture. As the airbreathing propulsion engine travels through the air, ambient air is compressed and forced into the engine where oxygen in the air is used as an oxidizer for the combustion of the solid fuel mixture. Combustion of the solid fuel mixture emits a stream of hot exhaust that is used to generate propulsion of the jet via a propulsion nozzle.

One form of an airbreathing jet engine is a so-called “ramjet” engine, also referred to in the art as a “flying stovepipe”, or an “athodyd” (aero thermodynamic duct). Ramjet engines use the forward motion of the engine to compress incoming air without using an axial or centrifugal compressor. Since the ramjet engine is designed to introduce the air to the solid fuel mixture for use as an oxidizer, fuels used for ramjet engines do not include a chemical oxidizer within the solid fuel mixture, increasing the energy density of the solid fuel mixture compared to solid fuel mixtures that require the oxidizer integrated within the solid fuel mixture. The absence of the chemical oxidizer in the solid fuel mixture reduces the weight of the engine for a given payload or increases the propulsion capabilities of the engine for a given mass of the solid fuel mixture.

Some ramjet fuel materials are liquid, while others are solid. Solid fuel ramjets (SFRJ) utilize solid fuel mixtures (e.g., solid propellants) to generate the thrust required to move the ramjet engine and a vehicle (e.g., aircraft, missile) to which the engine is mounted. However, conventional processing of solid fuels mixtures suffers due to the incompatibility of the fuel material with other components of the solid fuel mixture. Impurities in components of the solid fuel mixture formulation increase the difficulty of processing the solid fuel mixture. For example, reaction of impurities in one or more components of the solid fuel mixture with additional components of the solid fuel mixture may undesirably affect the processing of the solid fuel mixture, such as by increasing the viscosity of the solid fuel mixture composition. In some instances, the viscosity of the solid fuel mixture increases to such a degree that the solid fuel mixture composition cannot be adequately mixed prior to curing, hindering the completion of the solid fuel mixture.

### BRIEF SUMMARY

Embodiments disclosed herein include a method of forming a solid fuel, the method comprising passivating a fuel material comprising a metalloid. Passivating the fuel material comprises combining the fuel material, a solvent, and an isocyanate passivation agent to form a solution, and passivating exposed surfaces of the fuel material with the isocyanate passivation agent to form a passivated fuel material. The method further comprises combining the passivated fuel material with at least one binder to form a mixture, and combining a curing agent with the mixture to form a solid fuel.

In additional embodiments, a method of passivating amorphous boron comprises combining a passivation agent comprising at least one isocyanate compound with a solvent to form a mixture, adding amorphous boron to the mixture, reacting isocyanate functional groups of the at least one isocyanate compound with the amorphous boron to form particles of passivated amorphous boron, and separating the particles of passivated amorphous boron from the solvent.

In further embodiments, a method of forming a solid fuel ramjet engine comprises combining amorphous boron with an isocyanate compound in a solvent to form passivated amorphous boron, separating the passivated amorphous boron from the solvent, adding the passivated amorphous boron to a mixture comprising at least one binder and at least one plasticizer to form a fuel mixture, adding a curing agent to the fuel mixture to cure the fuel mixture and form a solid fuel, and disposing the solid fuel in a shell of a solid fuel ramjet engine.

In yet additional embodiments, a solid fuel comprises a fuel material comprising particles of boron, and a coating on at least one of the particles of boron, the coating comprising nitrogen-boron bonds and boron-oxygen double bonds. The solid fuel further comprises at least one binder, and at least one curing agent.

In additional embodiments, a solid fuel ramjet engine comprises a shell comprising an inner wall and an outer wall, and a solid fuel within the shell and in contact with the inner wall. The solid fuel comprises a fuel material, at least one binder, and at least one curing agent. The fuel material comprises particles of boron, and a coating on at least one of the particles of boron, the coating comprising nitrogen-boron bonds and boron-oxygen double bonds.

### BRIEF DESCRIPTION OF THE DRAWINGS

FIG. 1 is a simplified partial cross-sectional view of a solid fuel airbreathing propulsion engine, in accordance with embodiments of the disclosure;

FIG. 2 is a simplified flow chart illustrating a method of forming a solid fuel for a solid fuel airbreathing propulsion engine, in accordance with embodiments of the disclosure;

FIG. 3 is a simplified flow chart illustrating a method of passivating a fuel material, in accordance with embodiments of the disclosure; and

FIG. 4 is a simplified partial cross-sectional view illustrating a passivated fuel material, in accordance with embodiments of the disclosure.

### DETAILED DESCRIPTION

Illustrations presented herein are not meant to be actual views of any particular material, component, or system, but are merely idealized representations that are employed to describe embodiments of the disclosure. Additionally, elements common between figures may retain the same numerical designation for convenience and clarity.

The following description provides specific details, such as material types, compositions, material thicknesses, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry. In addition, the description provided below does not form a complete process flow for passivating a fuel material, for forming a solid fuel including the passivated fuel material, or for forming an article comprising the solid fuel. Only those process acts and structures necessary to understand the embodiments of the disclosure are described in detail below. Additional acts or materials to passivate a fuel material or form a solid fuel comprising the passivated fuel material may be performed by conventional techniques.

According to embodiments disclosed herein, a solid fuel (e.g., a solid propellant) for a propulsion engine, such as an airbreathing propulsion engine, includes a passivated fuel material (e.g., a passivated energetic material). The solid fuel is formed by combining (e.g., mixing) one or more binders with one or more plasticizers to form a mixture. In other embodiments, the fuel is formed by combining the passivated fuel material to at least one binder to form a mixture. The passivated fuel material is added to the mixture. In some embodiments, one or more combustion aids, one or more curing agents, or both are added to the mixture and the mixture is cured to form the solid fuel. Since the fuel material is passivated, the fuel material is substantially unreactive with other components of the solid fuel during processing of the solid fuel. The solid fuel is used, for example, in a solid fuel airbreathing propulsion engine, such as a ramjet engine.

The passivated fuel material is formed by introducing a fuel material (e.g., a particulate fuel material) to a solution comprising a passivation agent (e.g., a passivation material) dispersed in a solvent. The passivation agent is a chemical compound that includes at least one isocyanate functional group and may be referred to herein as an isocyanate compound. The at least one isocyanate functional group of the passivation agent may be selected to react with one or more impurities in the fuel material and surfaces of (e.g., functional groups on surfaces of) the fuel material. By way of non-limiting example, the at least one isocyanate functional group of the passivation agent may react with oxides (e.g., boron oxide) on exposed surfaces of the fuel material to form the passivated fuel material. In some embodiments, the fuel material comprises amorphous boron and the at least one isocyanate compound comprises isophorone diisocyanate (IPDI).

Including the passivated fuel material in the solid fuel facilitates processing of the solid fuel. For example, the passivated fuel material may not substantially react with one or more other components (e.g., ingredients) of the solid fuel during processing of the solid fuel. By way of comparison, conventional fuel materials that are not passivated (e.g., untreated fuel materials) may undesirably react with one or more other components of a conventional solid fuel during processing of the solid fuel. In addition, untreated fuel materials of conventional solid fuel are not easily incorporated into the solid fuel. As only one example, boron particles that are not passivated or that are treated with a chemical compound (e.g., an alcohol, such as triisopropanolamine (TIPA)) other than an isocyanate compound may undesirably react with a binder (e.g., a hydroxyl-terminated polybutadiene binder) during processing of the solid fuel. In particular, oxygen atoms of a boron oxide layer on the boron particles may react with functionally-terminated pre-polymers, such as with hydroxyl groups on the hydroxyl-terminated polybutadiene binder in the conventional solid fuel. The reaction of the boron with the binder increases the viscosity of the conventional solid fuel composition during processing, which reduces the flowability of the solid fuel composition and provides challenges to further processing of the conventional solid fuel composition. The increase in the viscosity of the conventional solid fuel composition caused by the reaction of the boron with the binder reduces the amount of boron that can be used in the solid fuel composition. The boron oxide on the boron particles also inhibits combustion of conventional solid fuel.

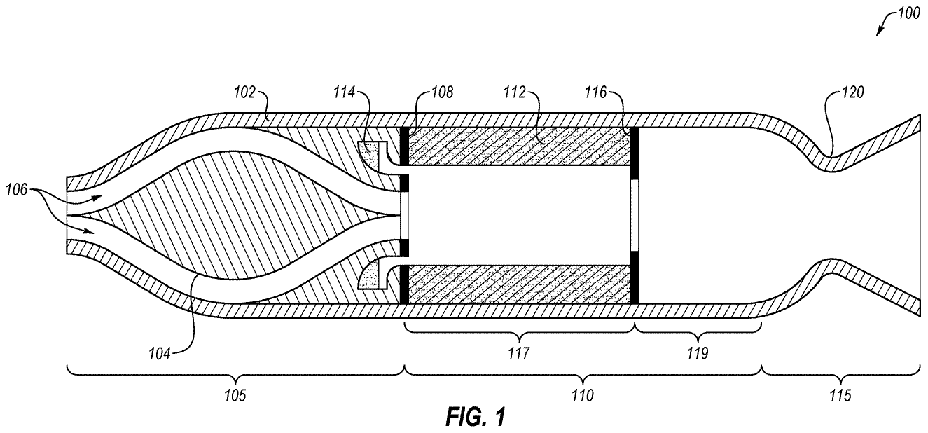

FIG. 1 is a simplified partial cross-sectional view of an airbreathing propulsion engine (e.g., a solid fuel airbreathing propulsion engine 100), in accordance with embodiments of the disclosure. The solid fuel airbreathing propulsion engine 100 may be referred to herein and in the art as a “solid fuel ramjet engine” (SFRJ). In some embodiments, the solid fuel airbreathing propulsion engine 100 comprises a supersonic combustion ramjet (“scramjet”) engine. The solid fuel airbreathing propulsion engine 100 may be used in propulsion systems, such as, for example, missile propulsion systems, aircraft propulsion systems, a portion of a staged space access propulsion system, or another type of aircraft. In some embodiments, the solid fuel airbreathing propulsion engine 100 may be used in artillery projectiles, such as extended range artillery projectiles.

The solid fuel airbreathing propulsion engine 100 comprises an air intake region 105, a combustor region 110 adjacent to the air intake region 105, and an exhaust region 115 adjacent to the combustor region 110. The combustor region 110 may be between the air intake region 105 and the exhaust region 115.

The solid fuel airbreathing propulsion engine 100 includes a shell 102 (also referred to as an “outer case”). A diffuser 104 extends within the air intake region 105 and at least partially defines an annular space 106 (also referred to as an “annular throat”) between the diffuser 104 and inner surfaces of the shell 102. The diffuser 104 may be mounted to the solid fuel airbreathing propulsion engine 100, such as to the inner wall of the shell 102. The diffuser 104 may be configured to compress air entering the air intake region 105 at the annular space 106 during forward motion (from the right direction to the left direction in the view of FIG. 1) of the solid fuel airbreathing propulsion engine 100. In use and operation, the solid fuel airbreathing propulsion engine 100 travels at supersonic velocities. In some embodiments, the diffuser 104 is configured to decelerate the incoming air entering at the annular space 106 from a supersonic velocity to a subsonic velocity upon exiting the air intake region 105 and entering the combustor region 110. Since the velocity of the air in the combustor region 110 is reduced to subsonic velocities, the combustor region 110 may also be referred to as a “subsonic stage”. In other embodiments, the diffuser 104 does not decelerate the incoming air to subsonic velocities. In some such embodiments, the solid fuel airbreathing propulsion engine 100 comprises a supersonic combustion ramjet engine (since combustion occurs at supersonic velocities).

A flame holder 108 may be located between the air intake region 105 and the combustor region 110. The flame holder 108 may be configured to facilitate continual combustion of a solid fuel 112 (e.g., a solid propellant) within the solid fuel airbreathing propulsion engine 100. The solid fuel 112 may include the passivated fuel material according to embodiments of the disclosure. The flame holder 108 may generate a low-speed eddy in the combustor region 110 to reduce a likelihood (e.g., prevent) the flame from being extinguished (e.g., blown out). The flame holder 108 may comprise, for example, an H-gutter flame holder, a V-gutter flame holder, or another type of flame holder.

With continued reference to FIG. 1, the combustor region 110 includes a solid fuel region 117 proximate the air intake region 105, and a mixing chamber 119 (also referred to as an “aft chamber”) proximate the solid fuel region 117. The solid fuel region 117 includes the solid fuel 112 in contact with an inner surface of the shell 102. The solid fuel 112 may include one or more materials formulated and configured to facilitate combustion sufficient to provide a motive force for the solid fuel airbreathing propulsion engine 100.

In some embodiments, an ignitor 114 is located proximate the solid propellant 112 prior to the solid fuel region 117 and is configured to facilitate ignition of the solid fuel 112 (i.e., initiation of combustion of the solid fuel 112). The ignitor 114 may include a combustible composition configured to combust prior to combustion of the solid fuel 112. Combustion of the ignitor 114 may provide at least one of preheating of the solid fuel 112 and initiating combustion of the solid fuel 112. In some embodiments, the combustible composition of the ignitor 114 comprises hydrogen and oxygen. In other embodiments, the solid fuel airbreathing propulsion engine 100 does not include an ignitor 114.

In some embodiments, a mixer plate 116 is located between the solid fuel region 117 and the mixing chamber 119. The mixer plate 116 may be configured to facilitate mixing of the solid fuel 112, combustion products of the solid fuel 112, and the air to form a combustion mixture. The solid fuel 112, combustion products of the solid fuel 112, and the air are mixed in the mixing chamber 119 to facilitate more complete combustion of the solid fuel 112.

As the combustion mixture passes through the mixing chamber 119, the combustion mixture is combusted to generate combustion products (also referred to as “exhaust products”). The combustion products exit the combustor region 110 and enter a nozzle 120 located within the exhaust region 115. The nozzle 120 may comprise a so-called “throat” or a “mechanical choke” of reduced transverse cross-section to increase the velocity of the combustion products as they pass through the exhaust region 115 and exit the nozzle 120 of the solid fuel airbreathing propulsion engine 100.

In use and operation, air enters the air intake region 105 while the solid fuel airbreathing propulsion engine 100 is traveling at supersonic velocities, such as at a velocity greater than two times the speed of sound (i.e., Mach 2), greater than three times the speed of sound (i.e., Mach 3), greater than four times the speed of sound (i.e., Mach 4), greater than six times the speed of sound (i.e., Mach 6), greater than ten times the speed of sound (i.e., Mach 10), or even greater than about fifteen times the speed of sound (i.e., Mach 15). The air enters the air intake region 105 at supersonic velocities and the velocity of the air is reduced as the air travels through the air intake region 105, beyond the diffuser 104, and into the combustor region 110.

In the combustor region 110, the air mixes with the solid fuel 112 to facilitate combustion of the solid fuel 112. The combustion products exit the combustor region 110 through the nozzle 120, which increases the velocity of the combustion products as they are exhausted to generate the propulsion of the solid fuel airbreathing propulsion engine 100.

The solid fuel 112 may include one or more fuel compositions (e.g., energetic compositions) configured to generate energy, upon combustion, for propulsion of the solid fuel airbreathing propulsion engine 100. The solid fuel 112 may include a fuel material (such as an energetic material) and one or more binder materials. The solid fuel 112 further comprises one or more additives, such as one or more of at least one plasticizer, at least one curing agent, and at least one combustion aid (also referred to herein as a catalyst or an initiator). The plasticizer and the combustion aid may be optionally present in the solid fuel 112. The at least one curing agent may also be referred to herein as a cross-linking agent.

The fuel material of the solid fuel 112 may include one or more of boron (e.g., elemental boron, amorphous elemental boron), boron carbide (B₄C), magnesium (e.g., elemental magnesium), aluminum (e.g., elemental aluminum), boranes (e.g., borane (BH₃), diborane (B₂H₆), tetraborane (B₄H₁₀), pentaborane (B₅H₉), decaborane (D₁₀H₁₄)), aluminum dodecaboride (AlB₁₂), borides of magnesium and silicon, aluminum boron nitride (AlBN), metal hydrides (e.g., beryllium hydride (BeH₂), zirconium hydride (ZrH₂), magnesium hydride (MgH₂), titanium hydride (TiH₂), aluminum hydride (AlH₃), aluminum borohydride (Al(BH₄)₃), lithium borohydride (LiBH₄)). In some embodiments, the fuel material comprises a metal. In other embodiments, the fuel material comprises a metalloid. Fuel materials are commercially available from numerous commercial sources, including, but not limited to, Merck KGaA of Darmstadt, Germany.

Boron exhibits a relatively high energy density per unit volume compared to other fuel materials and, thus, exhibits a relatively high theoretical energetic performance. In some embodiments, the fuel material comprises boron, such as amorphous boron. In other embodiments, the fuel material comprises a boron-containing compound, such as boron carbide.

In some embodiments, the fuel material comprises a passivated material such that the fuel material does not react with other components of the solid fuel 112 during processing of the solid fuel 112. In some embodiments, the fuel material comprises passivated amorphous boron. In some such embodiments, surfaces of the amorphous boron are passivated and are substantially free of boron oxide (B₂O₃), boron-oxygen single bonds, or other compounds that may undesirably react with one or more components of the solid fuel 112 during processing thereof. In contrast, boron that is not passivated, such as in conventional solid propellant materials, may comprise a boron oxide coating (e.g., a boron oxide layer) on surfaces thereof, which may react with one or more functional groups of the binder during processing of the solid fuel 112. Such a boron oxide coating comprises an oxygen atom bonded to two boron atoms, and each of the boron atoms double bonded to an additional oxygen atom (i.e., O═B—O—B═O).

The passivated fuel material may constitute from about 5 weight percent to about 60 weight percent of the composition of the solid fuel 112, such as from about 5 weight percent to about 10 weight percent, from about 10 weight percent to about 20 weight percent, from about 20 weight percent to about 30 weight percent, from about 30 weight percent to about 40 weight percent, from about 40 weight percent to about 50 weight percent, or from about 50 weight percent to about 60 weight percent of the solid fuel 112. In some embodiments, the passivated fuel material constitutes about 35 weight percent of the solid fuel 112. In other embodiments, the passivated fuel material constitutes about 50 weight percent of the solid fuel 112. In some embodiments, the passivated fuel material constitutes from about 25 weight percent to about 35 weight percent of the solid fuel 112. In other embodiments, the passivated fuel material constitutes from about 35 weight percent to about 45 weight percent of the solid fuel 112.

The binder of the solid fuel 112 may include one or more of hydroxyl-terminated polybutadiene (HTPB), polyethylene (PE), polybutadiene (PB), carboxyl-terminated polybutadiene (CTPB), hydroxyl-terminated polyether, polybutadiene acrylonitrile (PBAN), terathane/polyethylene glycol copolymer (TPEG), polymethylmethacrylate (PMM), lauryl methacrylate (C₁₆H₃₀O₂) (LMA), and a polymer of 3,3′bis(azidomethyl)-oxetane (BAMO) and 3-nitratomethyl-3-methyl oxetane (NMMO) (also referred to as poly(BAMO/NMMO)). In some embodiments, the binder comprises hydroxyl-terminated polybutadiene. The binder is commercially available from numerous commercial sources, including, but not limited to, Merck KGaA of Darmstadt, Germany.

The binder may constitute from about 30 weight percent to about 70 weight percent of the solid fuel 112, such as from about 30 weight percent to about 40 weight percent, from about 40 weight percent to about 50 weight percent, from about 50 weight percent to about 60 weight percent, or from about 60 weight percent to about 70 weight percent of the solid fuel 112.

The plasticizer, if present, may include one or more of dioctyl adipate (DOA), dioctyl sebacate (DOS), isodecyl pelargonate (IDP), hexanediol diacrylate (HDDA), triethylene glycol dimethacrylate (TEGDMA; TEGDM), glycidyl azide polymer (GAP) (such as low molecular weight GAP having a molecular weight from about 500 to about 700), organic phthalates (e.g., diethyl phthalate (DEP)), organic acetates, trimethylolethane trinate (TMETN), trimethylol nitromethane triazido acetate, 1,2,4-butanetriol (BTTN), diethylene glycol bis-azido acetate, and lecithin. In some embodiments, the plasticizer comprises dioctyl adipate. The plasticizer is commercially available from numerous commercial sources, including, but not limited to, The Chemical Company of Jamestown, R.I.

The plasticizer may constitute from about 2 weight percent to about 10 weight percent of the solid fuel 112, such as from about 2 weight percent to about 4 weight percent, from about 4 weight percent to about 6 weight percent, from about 6 weight percent to about 8 weight percent, or from about 8 weight percent to about 10 weight percent of the solid fuel 112. In some embodiments, the plasticizer comprises about 3 weight percent of the solid fuel 112.

The combustion aid, if present, may include one or more of polytetrafluoroethylene (PTFE), polyvinyl fluoride (PVF), fluorinated ethylene-propylene polymer (FEP), ethylene-tetrafluoroethylene (ETFE), perfluorinated polyether (PEPE), and one or more additional fluorine-containing materials (such as one or more fluorocarbons that facilitate ignition of boron particles). In some embodiments, the combustion aid comprises polytetrafluoroethylene. The combustion aid is commercially available from numerous commercial sources, including, but not limited to, AGC Chemicals Americas, Inc. of Exton, Pa.

The combustion aid may constitute from about 4 weight percent to about 15 weight percent of the solid fuel 112, such as from about 4 weight percent to about 6 weight percent, from about 6 weight percent to about 8 weight percent, from about 8 weight percent to about 10 weight percent, or from about 10 weight percent to about 15 weight percent of the solid fuel 112. In some embodiments, the combustion aid constitutes about 6.0 weight percent of the solid fuel 112.

The curing agent may include one or more of isophorone diisocyanate (IPDI) (C12H18N₂O₂), dimeryl diisocyanate (DDI), toluene diisocyanate (TDI) (C₉H₆N₂O₂), an epoxy curing agent (ECA), trimethylaziridinyl phosphine oxide (MAPO), and an aliphatic polyisocyanate. In some embodiments, the curing agent comprises isophorone diisocyanate. The curing agent is commercially available from numerous commercial sources, including, but not limited to, Merck KGaA of Darmstadt, Germany.

The curing agent may constitute from about 2 weight percent to about 10 weight percent of the solid fuel 112, such as from about 2 weight percent to about 4 weight percent, from about 4 weight percent to about 6 weight percent, from about 6 weight percent to about 8 weight percent, or from about 8 weight percent to about 10 weight percent of the solid fuel 112. In some embodiments, the curing agent comprises about 3.5 weight percent of the solid fuel 112.

In some embodiments, the solid fuel 112 comprises passivated amorphous boron, hydroxyl-terminated polybutadiene, dioctyl adipate, polytetrafluorethylene, and isophorone diisocyanate.

Although the solid fuel 112 has been described as comprising one or more different components (e.g., materials), the disclosure is not so limited. The solid fuel 112 may include compositions other than those described herein.

Although FIG. 1 has been described and illustrated as comprising a particular type of solid fuel airbreathing propulsion engine 100, the disclosure is not so limited. In other embodiments, the airbreathing propulsion engine may comprise one or more other types of solid fuel airbreathing propulsion engines including the solid fuel 112. Accordingly, the solid fuel 112 may be used for the propulsion of rockets, missiles, aircraft, space vehicles, ballistics, or other structures.

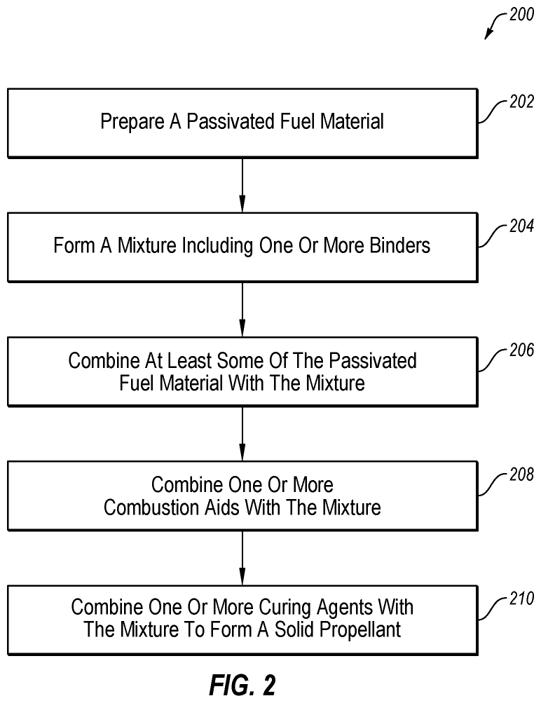

FIG. 2 is a simplified flow chart illustrating a method 200 of forming a solid fuel (e.g., the solid fuel 112) for a solid fuel airbreathing propulsion engine (e.g., the solid fuel airbreathing propulsion engine 100), in accordance with embodiments of the disclosure. The method 200 includes act 202 comprising preparing a passivated fuel material; act 204 comprising forming a mixture including one or more binders; act 206 comprising combining (e.g., adding) at least some of the passivated fuel material with the mixture; act 208 comprising combining (e.g., adding) one or more combustion aids with the mixture; and act 210 including combining (e.g., adding) one or more curing agents with the mixture to form the solid propellant.

Act 202 includes preparing a passivated fuel material. The fuel material may include one or more of the materials described above with reference to the fuel material of the solid fuel 112 (FIG. 1). In some embodiments, the fuel material comprises amorphous boron. In such embodiments, the amorphous boron may, initially, include a coating of boron oxide on surfaces thereof, which is subsequently replaced with a coating of a reaction product of boron oxide and the passivation agent.

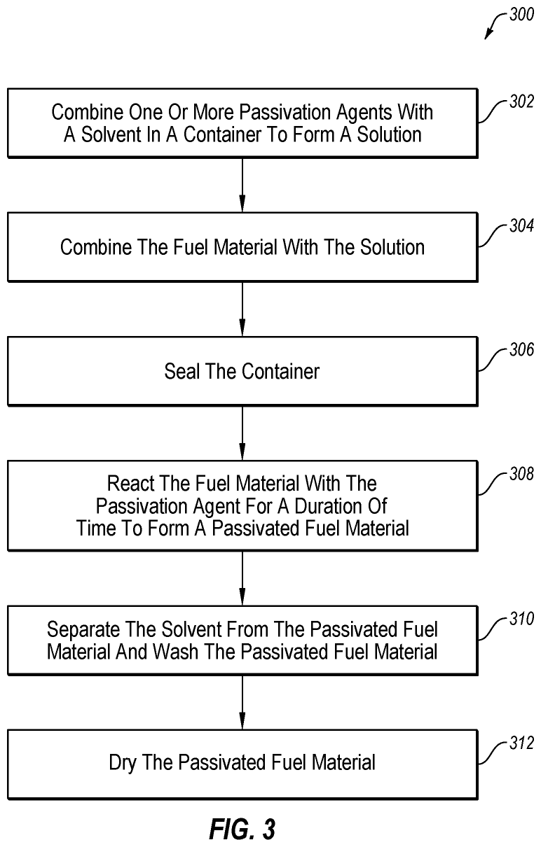

FIG. 3 is a simplified flow chart illustrating a method 300 of performing act 202, in accordance with embodiments of the disclosure. The method 300 comprises act 302 comprising combining one or more passivation agents with a solvent in a container to form a solution; act 304 comprising combining the fuel material with the solution; act 306 comprising sealing the container; act 308 comprising reacting the fuel material with the passivation agent for a duration of time to form a passivated fuel material; act 310 comprising separating the solvent from the passivated fuel material and washing the passivated fuel material; and act 312 comprising drying the passivated fuel material.

Act 302 comprises combining one or more passivation agents with a solvent in a container to form a solution. The one or more passivation agents may be formulated and configured to react with surfaces (e.g., functional groups on surfaces) of the fuel material to passivate exposed surfaces of the fuel material. In other words, the passivation agent may be formulated and configured to react with surfaces of the fuel material and passivate the fuel material to form a passivated fuel material that is not substantially reactive with one or more components of the solid propellant 112 (FIG. 1), such as with the binder of the solid fuel 112. For example, where exposed surfaces of the fuel material comprise boron oxide, the passivation agent is formulated and configured to react with oxygen atoms of the boron oxide to form a reaction product on the exposed surfaces of the boron that does not substantially react with components of the solid fuel 112 (FIG. 1).

The passivation agent may be an isocyanate compound, such as one or more of a monoisocyanate compound, a diisocyanate compound, or a polyisocyanate compound. The passivation agent may include one or more of isophorone diisocyanate, methylenebis(phenyl isocyanate) (also referred to as methylene diphenyl diisocyanate or 4,4′-methylenebis(phenyl isocyanate)) (MDI), toluene diisocyanate (TDI), hexamethylene diisocyanate (HDI), naphthalene diisocyanate (NDI), methylene bis-cyclohexylisocyanate (HMDI; hydrogenated MDI), octadecyl isocyanate (ODI), hexamethylene diisocyanate (HDI) biuret polyisocyanate, hexamethylene diisocyanate isocyanaurate, methyl isocyanate (MIC), methylene diphenyl diisocyanate (MDI), and phenyl isocyanate.

In some embodiments, the passivation agent comprises one or more diisocyanates. In some embodiments, the passivation agent comprises isophorone diisocyanate.

The solvent may include one or more materials in which the passivation agent is soluble. By way of non-limiting example, the solvent may include one or more of acetone, methanol, acetonitrile (ACN), ethanol, hexane, heptane, 2-butanone, chloroform, toluene, and ethylene glycol. In some embodiments, the solvent comprises methanol. In other embodiments, the solvent comprises acetone.

In some embodiments, the passivation agent is added to the solvent at a concentration within a range of from about 0.02 g/milliliter (g/mL) to about 0.20 g/mL, such as from about 0.02 g/mL to about 0.05 g/mL, from about 0.05 g/mL to about 0.10 g/mL, from about 0.10 g/mL to about 0.15 g/mL, or from about 0.15 g/mL to about 0.20 g/mL. In some embodiments, about 0.05 gram of the passivation agent is added to the solvent for every about 1.0 mL of the solvent. However, the disclosure is not so limited and the passivation agent may be added to the solvent at different concentrations than those described.

With continued reference to FIG. 3, act 304 comprises combining the fuel material to the solution containing the passivation agent. The fuel material may include one or more of the materials described above with reference to the fuel material of the solid fuel 112 (FIG. 1). In some embodiments, the fuel material comprises boron, such as amorphous elemental boron.

The fuel material may be a powder or other solid form. Particles of the fuel material may have a substantially spherical shape, a substantially cylindrical shape, a plate shape, or another shape. In some embodiments, the particles of the fuel material are spherical. However, the disclosure is not so limited and the shape of the particles of the fuel material may be different than that described.

A dimension (e.g., a diameter) of the particles of the fuel material may be within a range from about 1 micrometer (μm) to about 3 μm, such as from about 1.0 μm to about 1.5 μm, from about 1.5 μm to about 2.0 μm, from about 2.0 μm to about 2.5 μm, or from about 2.5 μm to about 3.0 μm. However, the disclosure is not so limited and the size of the particles of the fuel material may be different than that described. The particles of the fuel material may be monodisperse, wherein each of the particles exhibit substantially the same size and shape, or may be polydisperse, wherein the particles include a range of sizes and/or shapes.

In some embodiments, the fuel material may be added to the solution such that the solution comprises an excess amount of the passivation agent relative to the amount of the fuel material in the solution. In other words, after addition of the fuel material to the solution, the solution may comprise an excess of the passivation agent. Stated in yet another way, the amount of the passivation agent in the solution may be sufficient to passivate substantially all of the exposed surfaces of the fuel material and any contaminants present in the fuel material. In some embodiments, from about 5.0 grams to about 20.0 grams of the fuel material may be added to the solution for every about 1.0 gram of the passivation agent, such as from about 5.0 grams to about 7.5 grams, from about 7.5 grams to about 10.0 grams, from about 10.0 grams to about 15.0 grams, or from about 15.0 grams to about 20.0 grams of the fuel material for every about 1.0 gram of the passivation agent. In some embodiments, the solution may comprise less than about 20.0 grams of the fuel material for every about 1.0 gram of the passivation agent, such as less than about 15.0 grams, less than about 10.0 grams, or less than about 5.0 grams of the fuel material for every about 1.0 gram of the passivation agent.

Act 306 comprises sealing the container. In some embodiments, sealing the container includes isolating the solution from an external environment, such as from the atmosphere (e.g., air). In some embodiments, greater than about 70 volume percent of the container, such as greater than about 80 volume percent, or even greater than about 90 volume percent of the container is filled with the solution prior to sealing the container. In some embodiments, reducing the amount of volume of the container not occupied by the solution reduces the amount of air (e.g., moisture in the air) that may undesirably react with the passivation agent.

Act 308 comprises reacting the fuel material with the passivation agent for a duration of time to form a passivated fuel material. In some embodiments, reacting the fuel material with the passivation agent comprises mixing the container for at least a portion of the duration.

The duration may be within a range from about 1 hour to about 24 hours, such as from about 1 hour to about 2 hours, from about 2 hours to about 4 hours, from about 4 hours to about 6 hours, from about 6 hours to about 8 hours, from about 8 hours to about 12 hours, from about 12 hours to about 18 hours, or from about 18 hours to about 24 hours.

In some embodiments, act 308 includes heating the solution, such as to a temperature within a range from about 30° C. to about 75° C., such as from about 30° C. to about 50° C., or from about 50° C. to about 75° C.

In some embodiments, such as where the fuel material comprises amorphous boron and the passivation agent comprises an isocyanate compound, such as isophorone diisocyanate, reaction of the passivation agent with the fuel material forms a coating (e.g., a passivation coating) on surfaces of the fuel material. In some such embodiments, the passivated fuel material includes particles of the amorphous boron coated with a reaction product of the amorphous boron and the isocyanate compound. In some such embodiments, the reaction product comprises nitrogen atoms bonded to boron atoms (i.e., nitrogen-boron single bonds). In some embodiments, a single nitrogen atom is bonded to two boron atoms. The boron atoms may be double bonded to an oxygen atom (i.e., a boron-oxygen double bond). In some embodiments, the reaction product is substantially free of boron-oxygen single bonds.

In some embodiments, the reaction product also includes the nitrogen atom bonded to an R group of the isocyanate compound. In some embodiments, the nitrogen atom is bonded to a carbon atom (i.e., a nitrogen-carbon single bond). In some embodiments, at least some of the R groups may include an isocyanate group. In some embodiments, the R group comprises a cyclohexane group, such as 1,1-dimethylcyclohexane group. In some embodiments, the reaction product comprises a dioxyboryl compound (e.g., a compound comprising two boron atoms, each of which is independently bonded to an oxygen atom; (—(BO)₂). In some such embodiments, the reaction product may comprise an N,N-(dioxoboryl)-amine having the general formula N(BO)₂R.

By way of non-limiting example, the reaction between boron oxide and an isocyanate passivation agent is illustrated below, wherein the R—N═C═O chemical structure indicates the isocyanate passivation agent and the O═B—O—B═O chemical structure indicates the boron oxide in accordance with embodiments of the disclosure.

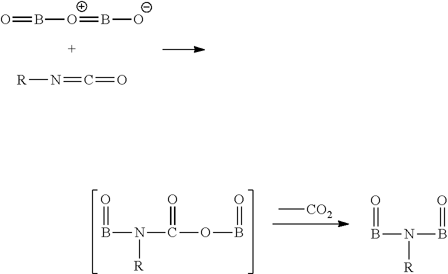

In the isocyanate passivation agent, R is a hydrogen or a hydrocarbon group (e.g., an alkyl group, a substituted alkyl group, a cycloalkyl group, an aryl group, a substituted aryl group, an arylalkyl group, or a substituted arylalkyl group). In some embodiments, the R group is a cyclohexyl group. With reference to reaction above, and without being limited to any particular theory, it is believed that the isocyanate passivation agent reacts with boron oxide to form a reaction product having a structure including a nitrogen atom (from the isocyanate group) bonded to a boron atom and to a carbon atom of the R group. The structure, in turn, is reacted to release carbon dioxide and to form a reaction product comprising a passivation coating material including a nitrogen atom bonded to two boron atoms. Each of the two boron atoms are, in turn, double bonded to an oxygen atom. The nitrogen atom is further bonded to the R group. By reacting the boron oxide with the isocyanate passivation agent, the boron oxide is not available to react with other components of the solid propellant 112. In some embodiments, the carbon dioxide is released from the reaction product when the reaction product is exposed to a relatively lower pressure (e.g., after the container is no longer sealed). Without being bound to any particular theory, it is believed that the carbon dioxide is released due to the elevated temperature of the drying process.

In some embodiments, a reaction between boron oxide and a passivation agent comprising isophorone diisocyanate forms a reaction product, the structure of which is illustrated below. Without being bound by any particular theory, it is believed that the reaction product comprises two nitrogen atoms, each of which is bonded to two boron atoms. Each of the four boron atoms is double bonded to an oxygen atom. The reaction product is substantially free of boron-oxygen single bonds.

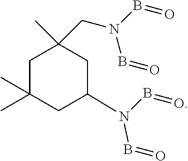 [SMILES: CC1(C)CC(N(B=O)B=O)CC(C)(CN(B=O)B=O)C1]

In some embodiments, the passivation agent further reacts with contaminants (e.g., moisture, oxygen) present within the container and facilitates removal of the contaminants from the solution.

With continued reference to FIG. 3, act 310 comprises separating the solvent from the passivated fuel material and washing the passivated fuel material. In some embodiments, the passivated fuel material is separated from the solvent by passing the solution through a filter and collecting the solid residue from the filter. The solid residue comprises the passivated fuel material.

Washing the passivated fuel material may include passing additional volumes of solvent through the solid residue to remove excess starting materials or undesirable byproducts. In some embodiments, the solid residue is rinsed with the additional solvent. The additional solvent may comprise substantially the same material composition as the solvent.

Act 312 comprises drying the passivated fuel material. The passivated fuel material may be exposed to a drying temperature for a predetermined duration to dry the passivated fuel material. The drying temperature may be selected to be less than a boiling temperature of the solvent. In some embodiments, the elevated temperature may be within a range of from about 37.8° C. (about 100° F.) to about 54.4° C. (about 130° F.), such as from about 37.8° C. (about 100° F.) to about 43.3° C. (about 110° F.), from about 43.3° C. (about 110° F.) to about 48.9° C. (about 120° F.), or from about 48.9° C. (about 120° F.) to about 54.4° C. (about 130° F.). In some embodiments, the drying temperature is about 48.9° C. (about 120° F.).

The duration may be within a range of from about 24 hours to about 96 hours, such as from about 24 hours to about 48 hours, from about 48 hours to about 72 hours, or from about 72 hours to about 96 hours. In some embodiments, the duration is about 72 hours.

In some embodiments, the dried passivated fuel material is screened to remove clumps or agglomerations of the dried passivated fuel material and to form a passivated fuel material having a desired particle size distribution (e.g., a substantially uniform particle size distribution).

In some embodiments, the passivated fuel material may comprise particles of the fuel material having a passivation coating thereon. The passivation coating may comprise a reaction product that includes boron-oxygen double bonds, nitrogen-boron single bonds, and may be substantially free of boron-oxygen single bonds. The passivation coating may partially coat or substantially coat the surfaces of the particles of fuel material.

In some embodiments, the passivated fuel material exhibits a larger dimension (e.g., diameter) than a corresponding dimension of the fuel material prior to passivation. In some embodiments, a diameter of the passivated fuel material may be within a range of from about 2 μm to about 4 μm, such as from about 2 μm to about 3 μm, or from about 3 μm to about 4 μm. In other embodiments, the diameter of the passivated fuel material is substantially the same as the diameter of the fuel material. In such embodiments, the passivated fuel material does not significantly increase the relative amount (e.g., relative mass) of the fuel material present in the solid fuel (e.g., the solid fuel 112 (FIG. 1)). Including the passivated fuel material according to embodiments of the disclosure in the solid fuel does not significantly increase the mass of the solid fuel in a propulsion engine containing the solid fuel. Therefore, the propulsion capabilities of the propulsion engine may be maintained for a given mass of the solid fuel.

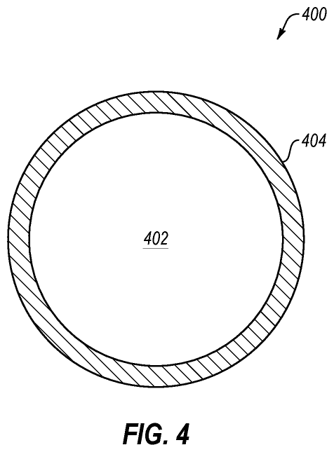

FIG. 4 is a simplified partial cross-sectional view illustrating a passivated fuel material 400, in accordance with embodiments of the disclosure. The passivated fuel material 400 comprises a core 402 comprising the fuel material and a coating 404 on at least some surfaces of the core 402. The coating 404 may include one or more of the materials described above. For example, the coating 404 may comprise a reaction product of the passivation agent and boron oxide. In some embodiments, the coating 404 comprises boron-oxygen double bonds and nitrogen-boron bonds.

Referring back to FIG. 2, act 204 comprises forming a mixture including one or more binders. The one or more binders may comprise one or more of the binders described above with reference to the one or more binders of the solid propellant 112 (FIG. 1). In some embodiments, the binder comprises hydroxyl-terminated polybutadiene. In some embodiments, the mixture may further include one or more plasticizers. The one or more plasticizers may include one or more of the materials described above with reference to the one or more plasticizers of the solid fuel 112 (FIG. 1). In some embodiments, the one or more plasticizers comprises diocytyl adipate.

Act 206 comprises combining at least some of the passivated fuel material with the mixture while mixing the mixture. In some embodiments, the passivated fuel material comprises passivated amorphous boron. In some embodiments, the passivated fuel material comprises a boron-containing material.

Act 208 comprises combining one or more combustion aids with the mixture while mixing the mixture. The combustion aid may comprise one or more of the materials described above with reference to the one or more combustion aids of the solid propellant 112 (FIG. 1). In some embodiments, the combustion aid comprises polytetrafluoroethylene.

Act 210 comprises combining one or more curing agents with the mixture to form a solid propellant. The curing agent may comprise one or more of the materials described above with reference to the one or more curing agents of the solid fuel 112 (FIG. 1). In some embodiments, the curing agent comprises isophorone diisocyanate. In some embodiments, the curing agent comprises substantially the same material composition as the passivation agent. In other embodiments, the curing agent comprises a different material composition than the passivation agent.

After adding the one or more curing agents to the mixture, the mixture may be exposed to curing conditions to cure the mixture and form the solid fuel 112. In some embodiments, the mixture is exposed to a cure temperature for a duration of time. By way of non-limiting example, the cure temperature may be within a range of from about 20° C. to about 100° C., such as from about 20° C. to about 40° C., from about 40° C. to about 60° C., from about 60° C. to about 80° C., or from about 80° C. to about 100° C. The duration of time may be within a range of from about 1 hour to about 14 days, such as from about 1 hour to about 6 hours, from about 6 hours to about 12 hours, from about 12 hours to about 24 hours, from about 1 day to about 2 days, from about 2 days to about 4 days, from about 4 days to about 7 days, or from about 7 days to about 14 days.

The solid fuel 112 including the passivated fuel material according to embodiments of the disclosure may include boron bonded to nitrogen atoms and also double bonded to oxygen atoms, as described above with reference to the passivated fuel material. For example, the solid fuel 112 includes nitrogen atoms, each nitrogen atom single bonded to a carbon atom and single bonded to two boron atoms. Each of the boron atoms is double bonded to an oxygen atom.

Forming the solid fuel 112 with the passivated fuel material may facilitate improved processing of the solid fuel 112. By way of non-limiting example, where the fuel material comprises amorphous boron, passivating the exposed surfaces of the amorphous boron with the passivation agent (e.g., isophorone diisocyanate) reacts the boron oxide coating (e.g., functional groups of the boron oxide) with functional groups of the passivation agent to form a passivated surface of the amorphous boron that is substantially free of boron-oxygen single bonds (which would react with the binder material (e.g., hydroxyl-terminated polybutadiene)) and comprising nitrogen-boron bonds and boron-oxygen double bonds. The passivated surface of the fuel material is substantially non-reactive with other components of the solid fuel 112 during processing of the solid fuel 112. For example, the passivated amorphous boron does not substantially react with hydroxyl groups of the binder, such as hydroxyl-terminated polybutadiene, during processing of the solid fuel 112 (e.g., during act 206 (FIG. 2)). The solid fuel 112 including the passivated fuel material may also exhibit a viscosity that is flowable at a processing temperature of the solid fuel 112. The solid fuel 112 including the passivated fuel material may, therefore, be sufficiently flowable to be cast into grains or other desired configurations. The solid fuel 112 may also exhibit improved insensitive munition (IM) properties compared to conventional solid propellants containing boron. The pot life (i.e., time the in-process solid propellant remains in a flowable state) of the solid fuel 112 according to embodiments of the disclosure may also be significantly increased compared to conventional solid propellants containing boron. It was unexpected that the passivated fuel material would improve the viscosity and flowability of the solid fuel 112 since conventional solid propellants containing boron are difficult to process and form a castable formulation given the reaction of unpassivated fuel materials with binder materials.

By way of comparison, processing of solid fuel materials containing boron by conventional methods does not include forming a passivation coating on the fuel material. Rather, the boron oxide on the surface of the boron undesirably reacts with the hydroxyl functional groups of the hydroxyl-terminated polybutadiene during processing of the solid fuel material, increasing the viscosity of the solid fuel mixture such that the solid fuel mixture is no longer flowable, reducing the ability to complete processing of the solid fuel mixture. Other methods of processing solid fuels include reacting the surfaces of the fuel material with an alcohol, such as triisopropanolamine (TIPA). However, such methods form a compound having the following structure and do not adequately passivate the surface of the fuel material and the fuel material is still susceptible to undesired side reactions with the other components of the solid fuel 112 during processing of the solid fuel 112.

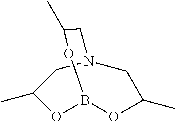

In addition, the amount of boron that may be processed by conventional processing methods in fuels including a hydroxyl-terminated polybutadiene binder is limited by the reaction of the boron with the hydroxyl-terminated polybutadiene and the resulting viscosity increase of the mixture. Forming the solid fuel 112 with the passivated fuel material according to embodiments of the disclosure facilitates improved processing of the solid fuel 112 and provides an increase in the weight percent of the fuel material present in the solid fuel 112. In some embodiments, processing the solid fuel 112 with the passivated fuel material facilitates forming the solid propellant to include greater than about 40 weight percent of the passivated fuel material, such as greater than about 50 weight percent, greater than about 55 weight percent, greater than about 60 weight percent, or greater than about 65 weight percent of the passivated fuel material in the solid fuel 112.

### EXAMPLES

### Example 1

Passivated amorphous boron was formed by mixing amorphous boron in a solution comprising isophorone diisocyanate dissolved in acetone. About 12.52 grams of isophorone diisocyanate was dissolved in about 250 mL of acetone. About 100.02 grams of amorphous boron was added to the solution and the solution was mixed to react the amorphous boron with the isophorone diisocyanate and form passivated amorphous boron particles. The passivated amorphous boron particles were used in a solid fuel composition.

### Example 2

About 46.96 grams of hydroxyl-terminated polybutadiene was mixed with about 2.71 grams of dioctyl adipate to form a mixture. The mixture was agitated with a mixer operating at a speed of about 2,500 rotations per minute. The temperature of the mixture was maintained at about 25° C. (about 77° F.). About 20.0 grams of the passivated amorphous boron of Example 1 was added to the mixture and the mixture was mixed for about one minute. An additional about 11.51 grams of the passivated amorphous boron was added to the mixture and the mixture was mixed for an additional 75 seconds. After adding the passivated amorphous boron, about 4.52 grams of polytetrafluoroethylene was added to the mixture and the mixture was mixed for about 75 seconds. About 4.34 grams of isophorone diisocyanate was added to the mixture and the mixture was mixed for about 30 seconds. The resulting mixture was cured to form a solid fuel having the composition shown in Table I.

TABLE I

| Component | Weight percent |
|---|---|
| Hydroxyl-terminated polybutadiene | 52.2 |
| Dioctyl adipate | 3.0 |
| Passivated amorphous boron | 35.0 |
| Polytetrafluoroethylene | 5.00 |
| Isophorone diisocyanate | 4.82 |

The solid fuel exhibited improved performance properties compared to solid fuels formed without passivated boron or with boron pretreated by other methods. For example, the solid fuel exhibited an increased modulus compared to a conventional solid fuel formulation. The passivated amorphous boron facilitated improved processing of the solid fuel, such as by reducing or eliminating reactions between the boron oxide and hydroxyl groups of the binder. The solid fuel exhibited a 100% modulus of about 5.578 MPa (about 809 psi) and a stress of about 5.895 MPa (about 855 psi) at about 25° C. and a 0.74/min strain rate compared to a conventional solid fuel formulation that exhibited a 100% modulus of about 3.337 MPa (about 484 psi) and a stress of about 2.434 MPa (about 353 psi) at about 25° C. and a 0.74/min strain rate.

While the disclosure is susceptible to various modifications and alternative forms, specific embodiments have been shown by way of example in the drawings and have been described in detail herein. However, the disclosure is not intended to be limited to the particular forms disclosed. Rather, the disclosure is to cover all modifications, equivalents, and alternatives falling within the scope of the disclosure as defined by the following appended claims and their legal equivalents.

1. A method of forming a solid fuel, the method comprising:
passivating a fuel material comprising a metalloid, passivating the fuel material comprising:
combining the fuel material, a solvent, and an isocyanate passivation agent to form a solution; and
passivating exposed surfaces of the fuel material with the isocyanate passivation agent to form a passivated fuel material;
combining the passivated fuel material with at least one binder to form a mixture; and
combining a curing agent with the mixture to form a solid fuel.

2. The method of claim 1, wherein passivating a fuel material comprises passivating amorphous boron.

3. The method of claim 1, wherein combining the fuel material, a solvent, and an isocyanate passivation agent to form a solution comprises combining amorphous boron with isophorone diisocyanate.

4. The method of claim 3, wherein combining the passivated fuel material with at least one binder to form a mixture comprises forming the mixture comprising hydroxyl-terminated polybutadiene.

5. The method of claim 1, wherein combining a curing agent with the mixture comprises combining isophorone diisocyanate with the mixture.

6. The method of claim 1, wherein combining a curing agent with the mixture to form a solid fuel comprises forming the solid fuel to comprise greater than about 40 weight percent of the passivated fuel material.

7. The method of claim 1, wherein passivating exposed surfaces of the fuel material with the isocyanate passivation agent comprises forming the passivated fuel material to comprise nitrogen-boron bonds.

8. The method of claim 1, wherein combining the passivated fuel material with at least one binder comprises combining the passivated fuel material with the at least one binder and at least one plasticizer.

9. The method of claim 8, wherein combining the passivated fuel material with the at least one binder and at least one plasticizer comprises combining the passivated fuel material with the at least one binder and at least one plasticizer comprising dioctyl adipate.

10. The method of claim 1, wherein combining the fuel material, a solvent, and an isocyanate passivation agent to form a solution comprises mixing the fuel material in a solvent comprising one of acetone or methanol to form the solution.

11. A method of passivating amorphous boron, the method comprising:
combining a passivation agent comprising at least one isocyanate compound with a solvent to form a mixture;
adding amorphous boron to the mixture;
reacting isocyanate functional groups of the at least one isocyanate compound with the amorphous boron to form particles of passivated amorphous boron; and
separating the particles of passivated amorphous boron from the solvent.

12. The method of claim 11, wherein adding amorphous boron to the mixture comprises adding particles of amorphous boron having a size within a range from about 1 μm to about 3 μm to the mixture.

13. The method of claim 11, wherein combining a passivation agent comprising at least one isocyanate compound with a solvent to form a mixture comprises combining a passivation agent comprising isophorone diisocyanate with a solvent selected from the group consisting of methanol, acetone, and acetonitrile.

14. The method of claim 11, wherein reacting isocyanate functional groups of the at least one isocyanate compound with the amorphous boron to form particles of passivated amorphous boron comprises forming boron-oxygen double bonds on surfaces of the particles of the passivated amorphous boron.

15. The method of claim 11, wherein adding amorphous boron to the mixture comprises adding from about 5.0 grams to about 10.0 grams of the amorphous boron to the mixture for every about 1.0 gram of the passivation agent.

16. The method of claim 11, wherein reacting isocyanate functional groups of the at least one isocyanate compound with the amorphous boron to form particles of passivated amorphous boron comprises forming nitrogen-carbon bonds on surfaces of the particles of the passivated amorphous boron particles.

17-22. (canceled)

23. The method of claim 1, further comprising separating the passivated fuel material from the solvent.

24. The method of claim 1, wherein combining the fuel material, a solvent, and an isocyanate passivation agent to form a solution comprises combining a fuel material comprising particles of amorphous boron having a size within a range from about 1 μm to about 3 μm with a solvent and an isocyanate passivation agent.

25. The method of claim 1, wherein passivating exposed surfaces of the fuel material with the isocyanate passivation agent comprises forming the passivated fuel material to comprise boron-oxygen double bonds on surfaces of the passivated fuel material.

26. The method of claim 1, wherein combining the fuel material, a solvent, and an isocyanate passivation agent to form a solution comprises forming the solution to include from about 5.0 grams to about 10.0 grams of amorphous boron for every about 1.0 gram of the isocyanate passivation agent.

27. The method of claim 1, wherein passivating exposed surfaces of the fuel material with the isocyanate passivation agent comprises forming the passivated fuel material to comprise nitrogen-carbon bonds on surfaces of the passivated fuel material.

28. The method of claim 1, wherein passivating exposed surfaces of the fuel material with the isocyanate passivation agent comprises forming the passivated fuel material to comprise a coating comprising a nitrogen atom bonded to two boron atoms.

29. The method of claim 28, wherein forming the passivated fuel material to comprise a coating comprising a nitrogen atom bonded to two boron atoms comprises forming the coating comprising the nitrogen atom bonded to two boron atoms, each of the two boron atoms individually double bonded to an oxygen atom.

30. The method of claim 1, wherein passivating exposed surfaces of the fuel material with the isocyanate passivation agent comprises forming the passivated fuel material to comprise the following structure:

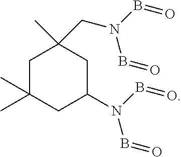 [SMILES: CC1(C)CC(N(B=O)B=O)CC(C)(CN(B=O)B=O)C1]

31. The method of claim 1, wherein combining the fuel material, a solvent, and an isocyanate passivation agent to form a solution comprises mixing amorphous boron with a diisocyanate to form the solution.
